(19) United States
(12) Patent Application Publication
(10) Pub. No.: US 2021/0218171 A1
(43) Pub. Date: Jul. 15, 2021

(54) COPPER STRIP FOR MAKING ELECTRICAL CONTACTS AND PROCESS FOR PRODUCING A COPPER STRIP AND CONNECTOR

(71) Applicant: AURUBIS STOLBERG GMBH & CO. KG, STOLBERG (DE)

(72) Inventors: BENJAMIN CAPPI, NEU-MORESNET (BE); HELGE LEHMANN, HUERTGENWALD (DE); KARL ZEIGER, ESCHWEILER (DE)

(21) Appl. No.: 17/055,016

(22) PCT Filed: May 21, 2019
(86) PCT No.: PCT/EP2019/063091

§ 371 Date: Nov. 12, 2020

(30) Foreign Application Priority Data
May 23, 2018 (DE) 10 2018 208 116.6

(51) Int. Cl. H01R 13/03; H01R 43/16; C25D 5/50; C25D 7/00; B32B 15/01; B32B 15/20; C23C 2/08; C23C 2/28

(52) U.S. Cl. CPC H01R 13/03; H01R 43/16; C25D 5/505; C23C 2/285; B32B 15/01; B32B 15/20; C23C 2/08; C25D 7/00

(57) ABSTRACT

The present invention concerns a copper strip for the making of electrical contacts, with a base material of copper or a copper alloy and a coating of tin, wherein the coating of tin has a proportion of insoluble, precipitation-forming elements of 0.003 to 1.0, preferably up to 0.5, preferably up to 0.05, particularly preferably up to 0.01 percent by weight. The invention further relates to a process for producing a copper strip for the manufacture of electrical contacts and a connector.

The present invention relates to a copper strip for making electrical contacts with a coating of tin having the characteristics of the generic term of claim 1 and a process for producing a copper strip having the characteristics of the generic term of claim 10 and a connector having the characteristics of the generic term of claim 14.

Copper strips are used to produce electrical contacts in plug contact connections. Such plug contact connections are used in various fields of application, such as in automotive electrics, telecommunications or industrial plant electronics. The electrical contacts in the plug contact connections serve to realize the electrically conductive connection and thus form the essential component of the plug contact connection. For this reason, the electrical contacts are subject to higher requirements regarding the reliability of the electrical connection up to a predetermined life time and after a predetermined number of plugging cycles under different temperature, humidity and load conditions. In addition, the vehicle manufacturers in particular demand that the insertion forces of the connectors do not exceed specified maximum values.

The copper strips and the electrical contacts made from them are made of copper or a copper alloy as a base material, which has proven to be advantageous due to its particularly good electrical conductivity. In order to protect against corrosion and wear as well as to lower the contact resistance and to reduce the insertion forces, it has also proven to be advantageous to provide the electrical contacts with a tin coating, which can be achieved, for example, by dip tinning the copper strips.

The electrical contacts are then usually punched out of the prefabricated, coated copper strips and formed to the predetermined shape in a multiple forming tool in a cold forming process.

Due to the high requirements made by vehicle manufacturers on the service life and functionality of the electrical contacts in general, even under extreme conditions, it can be problematic to meet the requirements regarding temperature resistance, relaxation resistance, corrosion resistance and adhesive strength of the coating. The adhesive strength of the coating is of particular importance here, since the contact area required for the electrically conductive connection is reduced or even completely interrupted by the separation of the coating (peeling off). The peeling off of the coating can be intensified or caused by diffusion processes between the copper base material and the tin coating and the Kirkendall pores created by this.

Such coated metal or even copper strips are known, for example, from the publications EP 1 288 321 B1, EP 1 158 618 B1 and EP 1 157 820 B1.

In order to improve the adhesive strength of the coating of said copper strips, various alloying elements are added to the copper, which is referred to as the base material there, which influence the diffusion behavior in the inter-metallic phase between the copper and the coating to such an extent that the formation of the Cu3Sn phase or ε phase, which is the cause of the dissolution, from the Cu6Sn5 phase or η phase is reduced.

A disadvantage of this solution, however, is that existing material standards for the base material cannot be met in extreme cases due to the modification of the base material. Furthermore, the properties of the base material, such as electrical conductivity, can be adversely affected. Furthermore, this solution cannot be used when using pure copper as the base material, e.g. Cu-ETP or Cu-OFE.

Against this background, the invention is based on the task of providing a copper strip for the production of electrical contacts with a tin coating, which should have an improved and in particular permanent adhesive strength of the coating and which can also be produced at low cost. Furthermore, the invention is based on the task of providing a process for producing a copper strip with an improved and permanent adhesive strength of the coating. Furthermore, the invention is based on the task of providing an improved connector made of such copper strip.

To solve the problem, a copper strip with the features of claim 1 is proposed. Additional preferred further developments can be found in the dependent claims, the figure and the corresponding description.

According to the invention, a copper strip for the production of electrical contacts, with a base material of copper or a copper alloy and a coating of tin is proposed for the solution of the problem, wherein the coating of tin has a proportion of insoluble, precipitation-forming elements of 0.003 to 1.0, preferably up to 0.5, preferably up to 0.05, particularly preferably up to 0.01 percent by weight.

The advantage of the proposed solution is first of all that the insoluble, precipitation-forming elements are deliberately included in the coating or tin layer and not in the base material as is the case in the prior art. Since the coating or tin layer is considerably thinner than the base material, a considerably smaller quantity of the insoluble, precipitation-forming elements is sufficient to produce the desired effect than is required when added to the base material. The effect of the improvement in adhesion strength is based on the fact that the insoluble, precipitation-forming elements deliberately form an intermetallic phase with the tin or even precipitates themselves, which reduces or suppresses the formation of the Cu3Sn phase (ε phase). This effect lowers the risk of the formation of the so-called Kirkendall pores, thus reducing the peeling-off effect and improving the adhesion strength of the coating to the base material. Since the insoluble, precipitation-forming elements are deliberately provided for in the coating or tin layer, the effect deliberately induced by these elements occurs specifically in the area and close to the boundary layer between the base material and the coating, which is particularly important for the adhesive strength, and the elements are used particularly well to achieve the resulting effect. The coating thus practically prevents even its own detachment from the base material. A further advantage is that the base material, i.e. the copper or copper alloy, does not need to be changed for the solution in accordance with the invention. Practically any copper or copper alloy can be used without a special addition of elements, as long as it meets the requirements for electrical conductivity. Furthermore, the copper alloy is not changed by the elements to be added, so that it is not negatively affected in terms of its electrical or technological properties.

It is further suggested that the precipitation-forming elements are formed by one or more of the following elements: Silver, germanium, nickel, cobalt in a proportion of 0.003 to 0.5 weight percent each. Silver (Ag) is insoluble in tin (Sn) even in the smallest amounts and forms an intermetallic phase Ag3Sn with the tin, which inhibits the formation of the Cu3Sn phase. A comparable effect can also be achieved by using germanium (Ge), nickel (Ni) and cobalt (Co), which form comparable intermetallic phases or precipitates, which in turn inhibit the formation of the Cu3Sn phase. Since the elements such as silver are very expensive, it is of particular advantage that the elements are deliberately only provided in the coating and not in the base material. The coating of the copper strip has a much smaller volume than the base material, so that a much smaller quantity of the added element is required to achieve the desired effect than would be necessary if the element were used in the base material. The production costs of copper strip can thus be reduced considerably. If several of the proposed elements are provided, the sum of the weight proportions of the individual elements should not exceed or fall below the limit values proposed in claim 1.

It is further proposed that the insoluble, precipitation-forming element silver is present in the coating in a proportion of 0.08 to 0.5 weight percent in the form of an Ag3Sn phase. Silver, as an insoluble, precipitation-forming element, has proven to be particularly preferred, since silver forms an Ag3Sn phase, which inhibits the diffusion of copper from the Cu6Sn5 phase and thus the formation of the disadvantageous Cu3Sn phase particularly well. In particular, the diffusion of copper and tin in the intermetallic phase region is influenced and thus the formation of the disadvantageous Cu3Sn phase is inhibited. The proposed proportion of silver has proven to be particularly effective in terms of effectivity while at the same time keeping the amount of expensive silver as low as possible. The silver-containing Ag3Sn phase is preferentially formed in the area of the Cu6Sn5 particles or around them and thus inhibits the growth of the Cu3Sn phase and thus the risk of the formation of Kirkendall pores particularly effectively.

The Ag3Sn phase is present in the coating preferably in particles with a mean area value of 0.01 to 0.03 μm², preferably 0.0140 to 0.0180 μm², which has proven to be sufficient to inhibit Cu3Sn growth. This area value can be adjusted both by measuring the amount of silver in the coating and by selecting the cooling method of the copper strip. The Ag3Sn phase can be present in the microstructure in either needle or platelet form, with the mean area value being valid for a closed section of the Ag3Sn phase in the microstructure.

Furthermore, the Ag3Sn phase in the coating is preferably present in particle sizes with an average circumference of 0.2 to 0.8 μm, preferably 0.4 to 0.6 μm, which has proven to be sufficient to inhibit Cu3Sn growth. This circumference value can also be adjusted both by measuring the amount of silver in the coating and by selecting the cooling form of the copper strip. As with the mean area value, the Ag3Sn phase can be present in a needle structure as well as in a platelet structure. In this case, too, the Ag3Sn phase is present in the needle structure or in the platelet structure in closed sections, and the suggested perimeter value is the averaged circumference value of a needle or a platelet in the structure.

It is further proposed that in the coating and/or in a boundary layer of the coating adjacent to the base material, a portion of the copper is present in a Cu6Sn5 phase and the Ag3Sn phase envelops the Cu6Sn5 phase. The Cu6Sn5 phase is thus isolated by the Ag3Sn phase from the copper diffusing out of the boundary layer, so that the formation of the Cu3Sn phase, which is responsible for the Kirkendall pores, can be inhibited particularly well.

It is further suggested that the precipitation-forming elements are formed by one or more of the following elements: Antimony or bismuth in a proportion of 0.02 to 1.0 weight percent. If several of the proposed elements are provided, the sum of the weight percentages of the individual elements should not exceed or fall below the limits proposed in claim 1. By using bismuth and antimony in the proposed weight percentage, a comparable effect can be achieved to that achieved by using silver, germanium, cobalt and nickel, although a combination of the elements described is of course also conceivable.

The copper alloy does not have any other element additions that influence the interdiffusion of the copper apart from the element additions permitted by the material standard, so that the effect to be achieved is exclusively based on the coating. Furthermore, the positive properties of the copper alloy with regard to current carrying capacity and electrical conductivity are generally not adversely affected.

It is further suggested that the coating has a higher hardness than the base material. Due to the higher hardness of the coating, the copper strip is more resistant to external mechanical influences and especially to abrasion and wear. The formation of the higher hardness is supported here by the addition of insoluble, precipitation-forming elements, so that the addition of these elements not only has the advantage of reducing the formation of Kirkendall pores, but also the advantage of improved mechanical properties. The higher hardness can be supported by the addition of the precipitation-forming elements as well as by an ageing of the copper strip at a certain temperature and over a certain period of time. Such an ageing process can, for example, take place over a period of 500 to 1500 h, preferably 1000 h at a temperature of 80 to 150° C., preferably at 130° C. The ageing process allows the Cu—Sn phases to grow to such an extent that there is no more free Sn in the coating. This microstructural transformation during ageing, caused by the presence of the Ag3Sn phase, deliberately increases the hardness of the coating compared to the initial state, so that the hardness of the coating is subsequently higher than the hardness of the base material. The microstructure transformation comprises a growth of the in-termetallic phase in the form of a diffusion process, which is caused by temperature and time. The microstructure transformation to the higher hardness also takes place without the presence of the Ag3Sn phase, but it is favored by the Ag3Sn phase, so that the presence of the Ag3Sn also has a favorable effect on the formation of the advantageous higher hardness. The ageing and microstructure transformation can take place not only under the above-mentioned controlled conditions, but also by transporting the copper strip over a longer distance, e.g. by shipping, or by using the copper strip in its processed form, e.g. as a connector, over a comparatively long period of time. Important for the microstructure transformation is only that the microstructure in the coating of the copper strip or in the product made from it is transformed in a thermal treatment, which can also be realized by a sufficiently long cooling phase, and that the higher hardness is achieved. The ageing or cooling under controlled conditions or simply by use represents a thermally induced structural transformation, which causes the higher hardness. In any case, the subsequent higher hardness has the advantage of an increased durability of the copper strip and the product manufactured from it.

Furthermore, a process for the production of a copper strip for the manufacture of electrical contacts, with a base material made of a copper alloy and a coating of tin is proposed for the solution of the task, in which the coating of tin is applied to the base material in a dipping process and/or an electroplating process with a proportion of insoluble, precipitation-forming elements of 0.003 to 1.0, preferably up to 0.5, preferably up to 0.05, particularly preferably up to 0.01 percent by weight. With the proposed process, any copper alloy can be coated with a tin coating with improved adhesion without the need to modify it. The improvement in the adhesive strength of the coating is achieved solely by the coating itself. Both dipping and electroplating processes are suitable for an even, large-area and cost-effective application of the coating in a predetermined, minimum thickness. A possible dipping process is, for example, a hot-dip tinning process in which the coating is liquid during the coating process and the desired microstructure then forms automatically during cooling.

It is further proposed that the insoluble, precipitation-forming elements are deposited on the base material in a first step in the electroplating process, and the tin coating is applied in a second step by the dipping process. The precipitation-forming elements insoluble in tin are first applied in a very thin coating to the copper strip or the base material formed by the copper alloy before the actual tin coating is applied in the dipping process. The elements which are the cause of the improvement in the adhesive strength or the phase of the elements formed thereby in connection with the tin are thus formed directly between the copper alloy and the tin, so that the diffusion of the copper required for the formation of the Cu3Sn phase is prevented or inhibited directly in the connection zone of the coating to the copper alloy. The galvanized coating of the copper alloy with the insoluble, precipitation-forming elements forms an intermediate phase together with the tin, which serves as a barrier layer for the copper. In addition, it is also possible that an intermediate layer is provided between the bismuth material and the coating. If the intermediate layer is made of copper or contains copper, the intermediate layer can also be called undercopper.

It is further suggested that the tin coating is applied by electroplating and is then subjected to a reflow treatment after application. In the reflow treatment, the tin of the coating is re-melted for a short period of time. In this way, an unfavorable microstructure formation in the coating, such as with long single crystals (whiskers), can be subsequently improved by recrystallization.

Furthermore, it is suggested that the copper strip be aged in air. The aging of the copper strip in air and the associated cooling results in the formation of the phase of the precipitation-forming elements required for inhibition of the Cu3Sn phase in a particle size or microstructure form which inhibits the subsequent diffusion of copper particularly effectively. By aging in air, the cooling process takes place over a sufficiently long period of time, which favors the formation of the favorable Ag3Sn phase in particular.

Furthermore, a connector made of a copper strip according to one of the claims 1 to 9 or a copper strip produced by a process according to one of the claims 10 to 13 is proposed to solve the task. The connector is punched out of the coated copper strip and bent into a complex, pre-determined geometry using a multiple forming tool.

The invention is explained in more detail below on the basis of preferred forms of execution with reference to the attached figure. Show

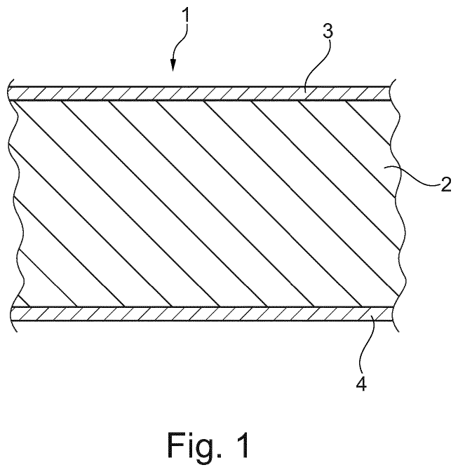

FIG. 1 a section through a copper strip with a tin coating according to the invention; and

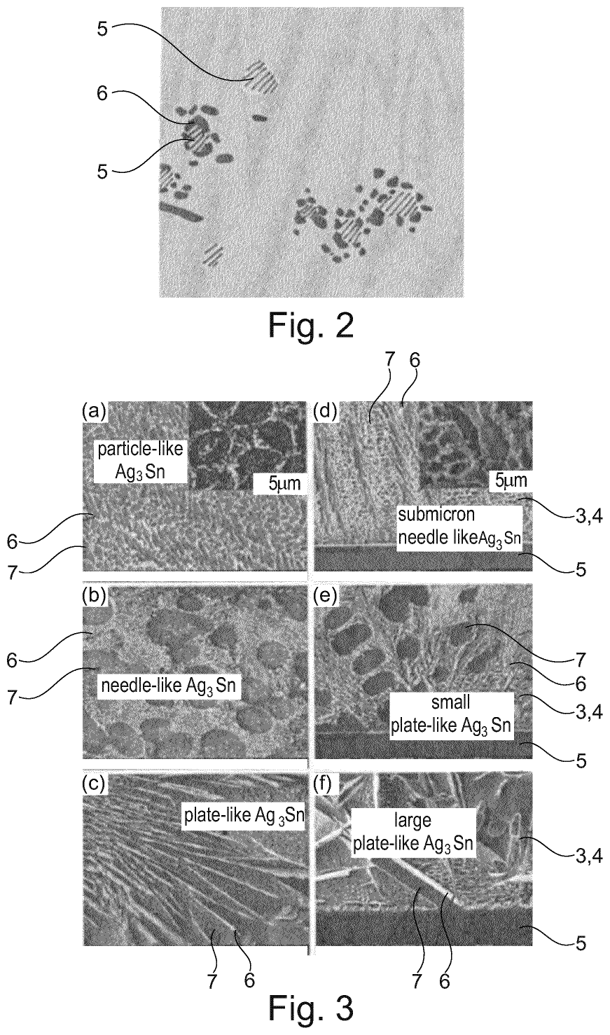

FIG. 2 a cutout of a microstructure of the coating formed by the alloy of the invention in an enlarged view; and

FIG. 3 different microstructures near the boundary layer and at a distance from the boundary layer after different cooling processes.

FIG. 1 shows a cutout of a copper strip 1 according to the invention for the manufacture of electrical contacts with a tin (Sn) coating 3, 4 on both sides in sectional view. The copper strip 1 has a base material 2 made of a known copper alloy, which does not have to meet any special requirements for the realization of the solution according to the invention and in particular does not have to be modified.

The base material 2 is coated on both sides in a dipping process with a coating 3, 4 consisting of a thin layer of tin (Sn). This tin contains the proportion of silver suggested by the invention. Silver is an element which is insoluble in tin even in the smallest amounts and thus deliberately forms precipitates, in this case the intermetallic intermediate phase Ag3Sn. The intermetallic intermediate phase is formed during the application of tin in the dipping process, when the tin solidifies on the base material. Furthermore, the particle size and shape can also be influenced subsequently, e.g. by thermal treatment. The quantity ratio of silver to tin is such that the weight proportion of silver in relation to tin is less than 1.0, preferably less than 0.5 weight percent. For cost reasons, the weight percentage of the expensive silver can be further reduced to below 0.1 weight percent or even below 0.05 weight percent, preferably to 0.01 weight percent. Even these very small amounts of silver in the tin coating are sufficient to form a sufficient intermediate phase Ag3Sn, which inhibits the diffusion of the copper and thus the formation of the Cu3Sn phase, thus increasing the adhesive strength due to the avoided Kirkendall pores.

Antimony (Sb), germanium (Ge), nickel (Ni), bismuth (Si) and cobalt (Co) can also be considered as alternative insoluble, precipitation-forming elements. The term insoluble and precipitation-forming is used to describe the property of producing precipitates in the coating, which can be formed either by intermetallic intermediate phases of the element together with the tin or by precipitates of the elements themselves. These precipitates serve to inhibit diffusion and the resulting formation of the Cu3Sn phase, which is responsible for the formation of the Kirkendall pores, so that the added elements reduce the formation of Kirkendall pores and increase the adhesive strength.

The precipitation-forming, insoluble element silver has been applied to the base material 2 by a dipping process, preferably by a hot-dip tinning process. However, it is also conceivable to apply the silver and tin in one or two steps, each in an electroplating process and/or in a combination of a dipping process and an electroplating process.

In this case, the coating 3, 4 can additionally be re-melted for a short time in a reflow process, whereby unfavorable structural properties can be eliminated.

FIG. 2 shows an enlarged microstructure of the tin-based coating, which can be achieved by adding silver in a proportion of 0.08 to 0.5 weight percent in coating 3, 4. Due to the addition of silver an Ag3Sn phase 6 is formed in the coating 3, 4 and especially in the boundary layer 5 to the base material 2, which can be seen in FIG. 3, which forms itself preferably around the Cu6Sn5 phase 5. The Ag3Sn phase 6 thus forms a kind of barrier or inhibition layer between the Cu6Sn5 phase 5 and the tin 7, which prevents or at least inhibits the formation of the Cu3Sn phase that causes the Kirkendall pores.

The Ag3Sn phase 6 forms by the addition in the proposed proportion range grains with a grain size with a mean area value of 0.01 to 0.03 μm², preferably of 0.0140 to 0.0180 μm² and an average circumference of 0.2 to 0.8 μm, preferably of 0.4 to 0.6 μm, which is optimal for the purpose of inhibiting the Ag3Sn phase while at the same time keeping the amount of silver as low as possible. The Ag3Sn phase 6 inhibits the diffusion of the copper necessary for the formation of the Cu3Sn phase in the area adjacent to the Cu6Sn5 phase 5, so that the formation of the Cu3Sn phase is inhibited. It is not inevitably necessary for the purpose to be achieved that the Cu6Sn5 phase 5 is completely envelooped by the Ag3Sn phase 6. It is also not a disadvantage if single grains of Cu6Sn5 phase 5 are not enveloped by Ag3Sn phase 6.

FIG. 3 shows different microstructures of Cu6Sn5 phase 5 and Ag3Sn phase 6, which are formed in the upper two illustrations by cooling with water, in the middle illustrations by cooling in air and in the lower figures by cooling in a furnace. In the left images, the microstructure can be seen at a distance from a Cu6Sn5 phase 5 not shown, while in the right images the microstructure near the Cu6Sn5 phase 5 can be seen.

In the upper illustrations it can be seen that the Ag3Sn phase 6 is formed in a particle structure between a residual portion 7 of the tin during rapid cooling or ageing by water, whereby the microstructure near Cu6Sn5 phase 5 is even finer. In the middle illustration, the microstructure can be seen after aging of copper strip 1 in air, in which the remaining portion 7 of tin has grown into coarser grains due to the longer cooling phase, and the Ag3Sn phase 6 is arranged in a fine needle structure between the remaining portion 7 tin. As can be seen in the middle, right illustration, the needle structure of Ag3Sn phase 6 is more pronounced near Cu6Sn5 phase 5. In the lower illustration it can be seen that the Ag3Sn phase 6 also grows into a more pronounced needle structure during aging in the furnace, i.e. with even longer cooling times, and that it also grows into a more pronounced needle structure.

The microstructures show that a desired needle-like morphology of Ag3Sn phase 6 and a sufficient encapsulation of Cu6Sn5 phase 5 by Ag3Sn phase 6 can be achieved by aging in air. Furthermore, since ageing in air is the most cost effective method of ageing, ageing in air is the preferred method for this purpose.

The boundary layer here is formed by a layer of Cu6Sn5 phase 5 and has a thickness of 10 to 100 μm. Depending on the amount of silver, this boundary layer can be thicker or thinner, and it can contain additional grains of Ag3Sn phase 6.

Another positive effect of adding the insoluble, precipitation-forming elements is that the hardness of the coating 3,4 is increased after thermal treatment or ageing and is ideally higher than the hardness of the base material 2. If silver is added as an insoluble, precipitation-forming element, the Ag3Sn phase 6 is formed during ageing according to the principle described above and thus leads to an increase in hardness. Preferably, the ageing is carried out in a temperature range of 80 to 150° C. over a period of 500 to 1500 hours to achieve the desired effect and the formation of the microstructure.

1-14. (canceled)

15. A copper strip for making electrical contacts, comprising:
a base material of copper or a copper alloy; and
a coating of tin,
wherein the coating of tin has a proportion of insoluble, precipitation-forming elements of 0.003 to 1.0 weight percent.

16. The copper strip according to claim 15, wherein the proportion of insoluble, precipitation-forming elements is up to 0.5 weight percent.

17. The copper strip according to claim 15, wherein the proportion of insoluble, precipitation-forming elements is up to 0.05 weight percent.

18. The copper strip according to claim 15, wherein the proportion of insoluble, precipitation-forming elements is up to 0.01 weight percent.

19. The copper strip according to claim 15,
wherein the insoluble, precipitation-forming elements are formed by one or more of the following elements:
silver, germanium, nickel, and cobalt in a proportion of 0.003 to 0.5 weight percent each.

20. The copper strip according to claim 15,
wherein the insoluble, precipitation-forming element silver is present in the coating of tin in a proportion of 0.08 to 0.5 weight percent in the form of an Ag₃Sn phase.

21. The copper strip according to claim 20,
wherein the Ag₃Sn phase is present in the coating of tin in particle sizes with a mean area value of 0.01 to 0.03 μm².

22. The copper strip according to claim 20,
wherein the Ag₃Sn phase is present in the coating of tin in particle sizes with a mean area value of 0.0140 to 0.0180 μm².

23. The copper strip according to claim 20,
wherein the Ag₃Sn phase is present in the coating of tin in particle sizes with an average circumference of 0.2 to 0.8 μm.

24. The copper strip according to claim 20,
wherein the Ag₃Sn phase is present in the coating of tin in particle sizes with an average circumference of 0.4 to 0.6 μm.

25. The copper strip according to claim 20,
wherein in the coating of tin and/or the base material a portion of the copper is present in a Cu₆Sn₅ phase, and the Ag₃Sn phase is present in the area of or envelops the Cu₆Sn₅ phase.

26. The copper strip according to claim 25,
wherein the Cu₆Sn₅ phase is arranged adjacent to an Ag₃Sn phase in or adjacent to a boundary layer between the base material and the coating of tin.

27. The copper strip according to claim 15,
wherein the insoluble, precipitation-forming elements are formed by one or more of the following elements:
antimony and bismuth in a proportion of 0.02 to 1.0 weight percent each.

28. The copper strip according to claim 15,
wherein the coating of tin has a higher hardness than the base material.

29. A process for producing a copper strip for the manufacture of electrical contacts, comprising:
providing a base material of copper or a copper alloy; and
applying a coating of tin to the base material in a dipping process and/or an electroplating process,
wherein the coating of tin has a proportion of insoluble, precipitation-forming elements of 0.003 to 1.0 percent by weight.

30. The process according to claim 29,
wherein the insoluble, precipitation-forming elements are deposited on the base material in a first step in the electroplating process, and
the coating of tin is applied in a second step by the dipping process.

31. The process according to claim 29,
wherein the coating of tin is applied by the electroplating process and is subjected to a reflow treatment after application.

32. The process according to claim 29,
wherein the copper strip is exposed to air.

33. A connector made from a copper strip according to claim 15.

34. A connector made from a copper strip produced by a process according to claim 29.
